(19) United States
(12) Patent Application Publication
(10) Pub. No.: US 2021/0280978 A1
(43) Pub. Date: Sep. 9, 2021

(54) RESONANT MULTI-RANGE ANTENNA

(71) Applicant: DEZEGA HOLDING UKRANE, LLC, Kyiv (UA)

(72) Inventors: Dmitry Vitalievich FEDOSOV, g. Omsk (RU); Roman Aleksandrovich BEKISHEV, g. Omsk (RU)

(21) Appl. No.: 17/258,179

(22) PCT Filed: Jul. 10, 2019
(86) PCT No.: PCT/RU2019/000491

§ 371 Date: Jan. 6, 2021

(30) Foreign Application Priority Data
Jul. 16, 2018 (RU) 2018126232

(51) Int. Cl. H01Q 9/22; H01Q 5/314

(52) U.S. Cl. CPC H01Q 9/22; H01Q 5/314

(57) ABSTRACT

The invention relates to antenna technology. An antenna comprises a matching device in the form of a transformer consisting of a primary winding and a secondary winding, a radiating vibrator in the form of a planar or three-dimensional conducting body, the radiating vibrator being connected to the secondary winding and arranged in a magnetic field of the matching transformer. Reactive discrete components (of capacitance, inductance) are galvanically connected within a gap to the matching transformer using controlled relays, or capacitive elements arranged alongside turns of the secondary winding of the transformer are connected using relays to one of the points of the transformer. The technical result is the capability of rapid retuning of the working frequency of the antenna in a broad range of frequencies and, consequently, the capability of compensating for the influence of external objects which have capacitance, and switching to other radio signal reception and transmission frequency channels.

The invention relates to antenna technology and can be used in small-sized transmitting and receiving equipment of the medium-wave range for mobile radio communication and inductive communication and as a separate antenna arranged to be installed on stationary and communication objects. This is very important in mines and grooves, where there are many cables along which medium-wave signals propagate well in almost every mine work.

It is now known that the dimensions of effective modern antennas of the hectometer and decameter ranges of radio waves are tens and hundreds of meters, which significantly reduces the capability of their use in mobile radio communications. And in a mine in a confined space it makes their use almost impossible, since the time of stationary installation of antennas for radio communication increases and there may be no conditions for its installation. Such types of antennas hamper the development and use of both the hectometer and decameter radio communication itself and designs of transmitting and receiving devices in the field of long-wave, medium-wave and short-wave radio communication. These radio wave ranges seem to be the most attractive for communication in mines, both directly through the rock and using induction, since such signals well and with minimal losses are propagated along cable lines.

According to the utility model patent RU 154886 an antenna which consists of a thin vibrator, a transformer on a ferrite ring, an extension coil and a counterweight is known. In this antenna frequency retuning is carried out using a mobile electrode connected to the counterweight inside the extension coil, with the turns of which this electrode forms a capacitive coupling and shunts the extension coil.

This design cannot be used as a portable antenna, since the presence of a counterweight significantly increases mass-dimensional parameters of the antenna. Moreover, such a design, where a thin long vibrator is used, will be inconvenient as a portable one in underground structures—mines and caves.

The design of the proposed antenna is devoid of ferrite cores, which significantly increases the maximum power level of the input signal.

The antenna consists of a vibrator—a radiating element representing a 2D flat or 3D three-dimensional conducting body with an electrical capacitance. It will be most convenient to use a vertically or horizontally located conducting cylinder as such a vibrator. The antenna includes a matching transformer in the form of a primary winding and a secondary winding. The transformer is located in such a way that the magnetic field of the transformer goes beyond its limits and encompasses the vibrator. The magnetic field of the transformer is a rather rapidly decreasing field in its value, actually concentrated in a space not exceeding several units of the linear dimensions of the transformer itself, as a rule, this space dimension is less than 1% of the wavelength emitted by the antenna. To retune the resonant frequency a system of reactive components (capacitances, capacitors) connected using relays is introduced into the gap of the transformer, or several capacitive elements arranged near the turns of the secondary winding of the transformer are connected using relays to one of the points of the transformer.

Thus, the antenna enables users of mine induction communication systems to communicate on the move along induction communication lines. In addition, the capability of almost instantaneous switching of the frequency channel in the antenna makes it possible to use it in multichannel communication and queuing systems, which could not be achieved under conditions of smooth adjustment of the resonant frequency of the emitting and transmitting devices.

The closest analogue in technical essence to the claimed devices is the antenna according to the utility model patent RU 174319 “Mobile middle-wave band/short-wave band (MWB/SWB) vibrator antenna”. This antenna contains a thin vibrator, a matching transformer, a counterweight and an extension coil, inside which shunt capacitive elements are inserted and connected through a switching device to the counterweight. The disadvantage of this design is the presence of a counterweight, which limits the use of this antenna as a portable one. The presence of a long, thin vibrator makes it difficult to use this antenna in mines and caves. The power input is limited by the saturation magnetic field of the transformer on the ring ferromagnetic core.

The technical result of the claimed invention consists in the capability of retuning of the working frequency of a small-sized antenna in a fairly broad range when using signal sources of increased power in tens and hundreds of watts while maintaining its small overall dimensions, which expands the functionality of radio equipment, especially in a confined volume (mines, caves).

The specified technical result is achieved by the fact that in an antenna comprising a matching device in the form of a transformer, consisting of a primary winding and a secondary winding located nearby on the same axis, as well as a vibrator in the form of a flat or three-dimensional conducting body located in the magnetic field of the transformer and connected to its secondary winding, reactive discrete components (of capacitance, inductance) are galvanically connected within a gap to the matching transformer using controlled relays, or capacitive elements arranged alongside turns of the secondary winding of the transformer are connected using relays to one of the points of the transformer.

In addition, to make the antenna dual- or multi-band, the primary winding and the secondary winding of the transformer can be composed of sections that are connected using relays. So, for example, it is possible to make a dual-band antenna with a retuning in each range, if the primary winding and the secondary winding consist of two connected sections. When all sections are connected, the lower range will operate, in case of disconnection in one of the sections at the secondary winding and the primary winding, the antenna will operate in the upper range of radio signals.

To control such an antenna, in addition to supplying an HF radio signal, it is also necessary to supply a power and control signal from the radio station.

To simplify the antenna connection to any radio station, even one that does not have special functions for supplying power and control commands to the antenna, the antenna is equipped with a power supply element (battery), a processor and a current and voltage sensor in the high-frequency line to determine the level of the current antenna tuning to achieve resonance. In addition, an ionistor, which is charged from the HF-line, can be used as a power source of the antenna. This design of the antenna requires only two wires to supply only the HF-signal. After measuring the current and voltage in the high-frequency line, the processor determines the required discrete reactive elements L and C to be connected using relays that it controls. Next, the necessary elements are switched on, and the antenna works in resonance with maximum efficiency.

The invention can be implemented industrially using known technical means, technologies and materials.

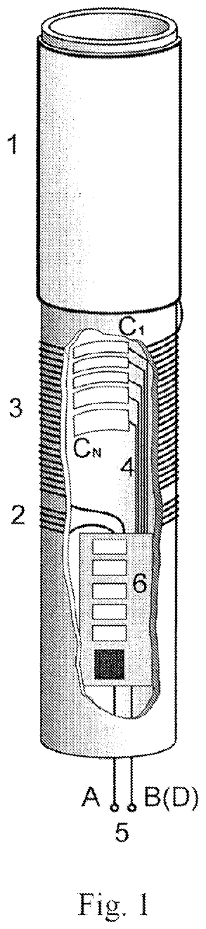

The invention is illustrated by drawings, where FIG. 1 shows the structural diagram of the antenna.

A dielectric tube is used as an antenna frame and a connection device, on which a three-dimensional conducting vibrator 1 is placed in the form of a cylinder. It can be made of foil glued to the frame.

The primary winding 2 and the secondary winding 3 of the transformer are arranged on the frame. Inside the frame, discrete capacitive elements in the form of foil strips are inserted on its wall and located opposite the turns of the secondary winding of the transformer and form together with these turns capacities C₁, C₂ . . . C_{N}.

Below the primary winding of the transformer are the antenna input 5, formed by the connection points A and B, and the antenna control board containing the relay unit 6, which connects the discrete capacities C₁, C₂ . . . C_{N} of the transformer circuit.

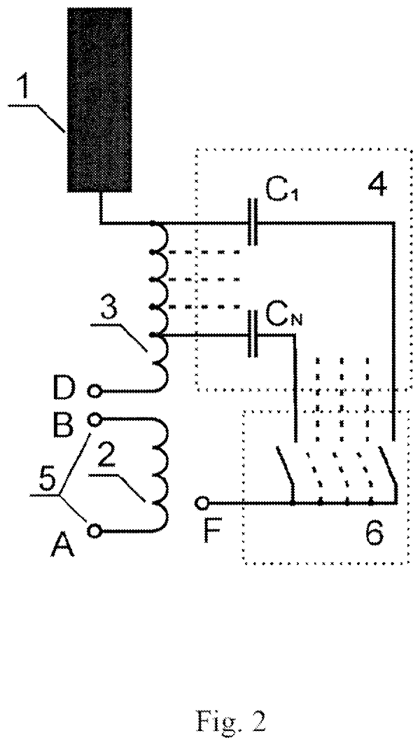

FIG. 2 shows the electrical circuit of the antenna in the case of using as discrete reactive elements of the electrodes located near the secondary winding of the transformer and forming capacities C₁, C₂ . . . C_{N} with it. A set of these capacities forms a reactive system 4.

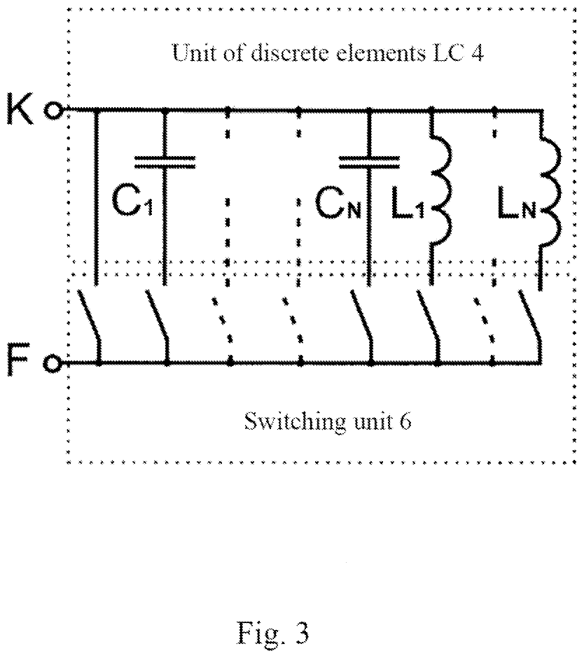

FIG. 3 shows the electrical diagram of a variant of a system of reactive elements 4 of L and C components connected by means of a relay unit 6 within a gap of the inductances of the transformer in series with them, for example, between points B and D.

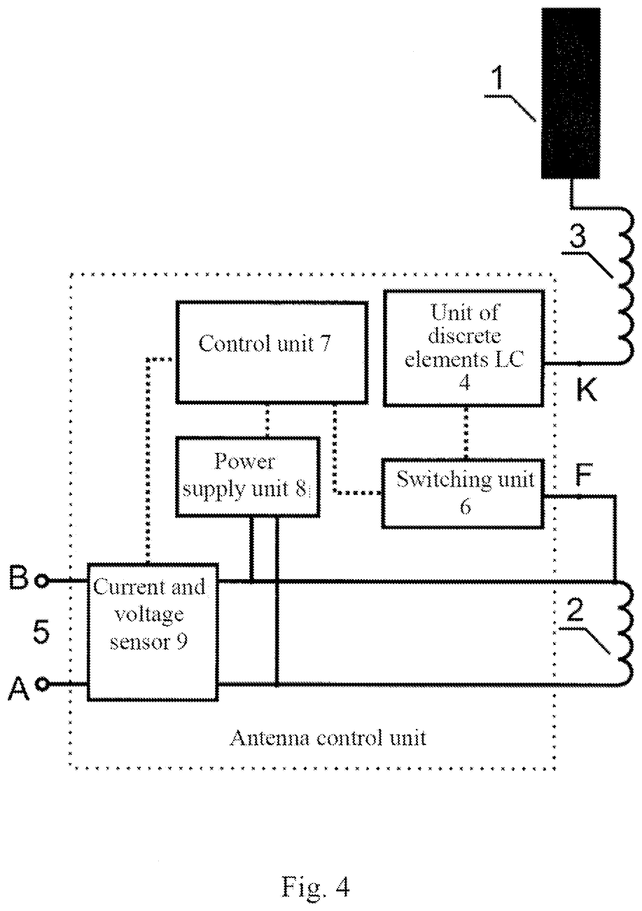

FIG. 4 shows the combined electrical and structural diagram of the antenna, where discrete components L and C are used as reactive elements.

The antenna consists of the transformer with the primary inductance winding 2 and secondary inductance winding 3, between which a system of controlled relays 6 and a block of discrete elements L and C 4 connected using relays are included. The relays are controlled and switched by the processor control unit 7, which is powered by the power supply unit and power take-off is provided from the high-frequency line 8. Data on the current operating mode of the antenna and its SWR are determined using a current and voltage sensor 9, located on the high-frequency line that feeds the antenna. Having received data from the current and voltage sensor, the processor calculates the offset of the antenna working point relative to the current frequency and issues a relay a command to connect or disconnect certain discrete elements L, C in order to change the antenna tuning. Thus, the antenna itself monitors the correspondence of its resonant frequency to the frequency of the supplied signal.

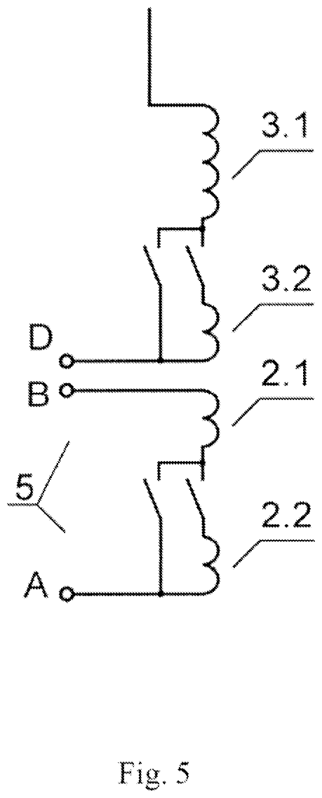

FIG. 5 shows the electrical diagram of the transformer for a dual-band antenna. The primary winding 2 consists of two successive inductor coils 2.1 and 2.2, and the secondary winding 3 consists of two successive inductor coils 3.1 and 3.2. The coils 2.2 and 3.2 can be disabled or enabled using relays. If they are turned on, the antenna operates in a lower range of radio signals, and if they are turned off—in a higher frequency range. Fine tuning of the frequency is achieved using a system of connected reactive elements.

The antenna operates as follows.

When a high-frequency signal is applied to the primary winding 2 of the transformer, a magnetic field inducing a magnetic field in the secondary winding 3 arises in it. A magnetic field with the magnetic induction vector directed along the secondary winding arises around the transformer. The electric field, the intensity vector of which is directed perpendicular to the surface of the vibrator 1, arises due to the supply of high voltage to it from the secondary step-up winding 3 of the transformer, which is electrically connected to the vibrator 1. Proceeding from the fact that the surface of the vibrator 1 is in the zone of action of the magnetic field of the transformer, so that the angle between the vector of magnetic induction and the vector of the intensity of the electric field arising on the vibrator is close to 90°, conditions sufficient for the formation of radio waves arise near the vibrator.

Since this antenna is resonant and is an open oscillatory circuit, the introduction of any reactive elements into this circuit will change the resonant frequency. A connection of discrete additional inductances and capacitors using relays in series with the inductances of the transformer or a galvanic connection of capacitive elements shunting the secondary winding of the transformer to the transformer will cause a change in the resonant frequency and retune the antenna to a different frequency. This enables to retune the antenna frequency in the range of 10-20% of the center frequency of the range. To switch to another range, it is required to disconnect or connect parts of the sections of the primary winding 2 and secondary winding 3 of the transformer.

1. An antenna with a matching device, comprising a matching device in the form of a transformer, consisting of a primary winding and a secondary winding, a radiating vibrator in the form of a planar or three-dimensional conducting body, the radiating vibrator being connected to the secondary winding and arranged in a magnetic field of the matching transformer, wherein reactive discrete components (of capacitance, inductance) are galvanically connected within a gap to the matching transformer using controlled relays, or capacitive elements arranged alongside turns of the secondary winding of the transformer are connected using relays to one of the points of the transformer.

2. The antenna according to claim 1, wherein it comprises power supply elements, a processor that controls the relays, a current and voltage sensor in the high-frequency line that feeds the antenna.

3. The antenna according to claim 1, wherein it comprises a processor that controls the relays, an ionistor feeding the electrical circuit of the antenna and being charged from a high-frequency signal supplied to the antenna by a radio transmitter, a current and voltage sensor in the high-frequency line that feeds the antenna.

4. The antenna according to claim 1, wherein the primary winding and the secondary winding are divided into several sections, which are connected using relays.
